(19) United States
(12) Patent Application Publication
(10) Pub. No.: US 2020/0390037 A1
(43) Pub. Date: Dec. 17, 2020

(54) AGRICULTURAL HARVESTER WITH CONVEYOR BELT SYSTEM

(71) Applicant: CNH Industrial America LLC, New Holland, PA (US)

(72) Inventor: Donald Paul Keller, Narvon, PA (US)

(73) Assignee: CNH Industrial America LLC

(21) Appl. No.: 16/438,098

(22) Filed: Jun. 11, 2019

(51) Int. Cl. A01D 61/00

(52) U.S. Cl. CPC A01D 61/00; A01D 46/08

(57) ABSTRACT

An agricultural harvester may have a conveyor belt system that facilitates delivery of harvested crops from one or more heads to a storage region of the agricultural harvester. The conveyor belt system may have a first conveyor belt, a second conveyor belt disposed a distance from the first conveyor belt, and a third conveyor belt that may provide harvested crops to a region between the first conveyor belt and the second conveyor belt. The first conveyor belt and the second conveyor belt may rotate in opposite directions to facilitate delivery of the harvested crops to the storage region.

### BACKGROUND

The present disclosure relates to agricultural equipment, and more particularly to an agricultural harvester having a conveyor belt system for delivering crops to a storage region of the agricultural harvester.

An agricultural harvester may be used to harvest agricultural crops, such as corn, wheat, flax, cotton, or hay. Generally, components (e.g., heads, spindles, blades, etc.) within a header of the agricultural harvester engage and collect the agricultural crops as the agricultural harvester traverses a field. Typically, the agricultural harvester may utilize a pneumatic system to move the harvested crops through the agricultural harvester to a storage region of the agricultural harvester. The pneumatic system of the agricultural harvester may have a complex structure that includes many different components, such as multiple conveyor fans, plenums, and air tubes. Additionally, the pneumatic system may add air to the harvested crops as the harvested crops are delivered to the storage region of the agricultural harvester, thereby decreasing an amount of crops that may be stored within the agricultural harvester.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, an agricultural harvester may have a conveyor belt system that facilitates delivery of harvested crops from one or more heads to a storage region of the agricultural harvester. The conveyor belt system may have a first conveyor belt, a second conveyor belt disposed a distance from the first conveyor belt, and a third conveyor belt that may provide harvested crops to a region between the first conveyor belt and the second conveyor belt. The first conveyor belt and the second conveyor belt may rotate in opposite directions to facilitate delivery of the harvested crops to the storage region.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic side view of an embodiment of an agricultural harvester having a conveyor belt system to convey harvested crops to a storage region of the agricultural harvester;

FIG. 2 is a schematic top view of the agricultural harvester of FIG. 1 having heads configured to engage and collect agricultural crops as the agricultural harvester traverses a field; and

FIG. 3 is a schematic side view of the conveyor belt system of FIG. 1 having conveyor belts utilized to convey harvested crops from a head to the storage region of the agricultural harvester.

### DETAILED DESCRIPTION

One or more specific embodiments of the present disclosure will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Conventional agricultural harvesters may utilize a pneumatic system to move harvested crops (e.g., cotton or hay) from a head to a storage region of the agricultural harvester. The pneumatic system of the agricultural harvester may have a complex structure that includes many different components, such as multiple conveyor fans, plenums, and air tubes, thereby increasing manufacturing and maintenance costs associated with the agricultural harvester. Additionally, the pneumatic system may introduce air to the harvested crops as the harvested crops are delivered to the storage region of the agricultural harvester, thereby decreasing an amount of crops that may be stored in the agricultural harvester. For example, as the agricultural harvester collects cotton from a field, the cotton may flow from the head to the storage region of the agricultural harvester via the pneumatic system. However, the pneumatic system may cause the cotton to fluff as air is introduced into the flow of the cotton to the storage region, thereby increasing the storage volume of the cotton in the storage region. As such, it may be desirable to use an improved agricultural harvester that utilizes a harvested crop delivery system having fewer components than the pneumatic system and that increases the amount of crops that may be stored in the agricultural harvester by substantially reducing the amount of air introduced to the harvested crops as the harvested crops are delivered to the storage region of the agricultural harvester.

Embodiments of the present disclosure are directed to an improved agricultural harvester having a conveyor belt system that has relatively fewer components than the pneumatic system and that substantially reduces the amount of air introduced to the harvested crops as the harvested crops are delivered to the storage region of the agricultural harvester. For example, the agricultural harvester may have conveyor belts that move the harvested crops from one or more heads of the agricultural harvester to the storage region. The conveyor belts may include an initial conveyor belt that conveys the harvested crops from the head(s) of the agricultural harvester to a pair of opposing conveyor belts that rotate in opposite directions to move the harvested crops to the storage region of the agricultural harvester. As such, the amount of air introduced to the harvested crops as the harvested crops are delivered to the storage region from the head(s) is substantially reduced as compared to that of a pneumatic system.

Additionally, various parameters of the conveyor belt system may be adjustable for various crop yields. The distance between the conveyor belts and the belt speed of the conveyor belts may be increased or decreased based on the amount of crops harvested via the heads of the agricultural harvester. The distance between the conveyor belts may also be adjustable to facilitate compression of the harvested crops as the harvested crops are delivered to the storage region of the agricultural harvester, thereby increasing the amount of crops that may be collected and stored in the agricultural harvester.

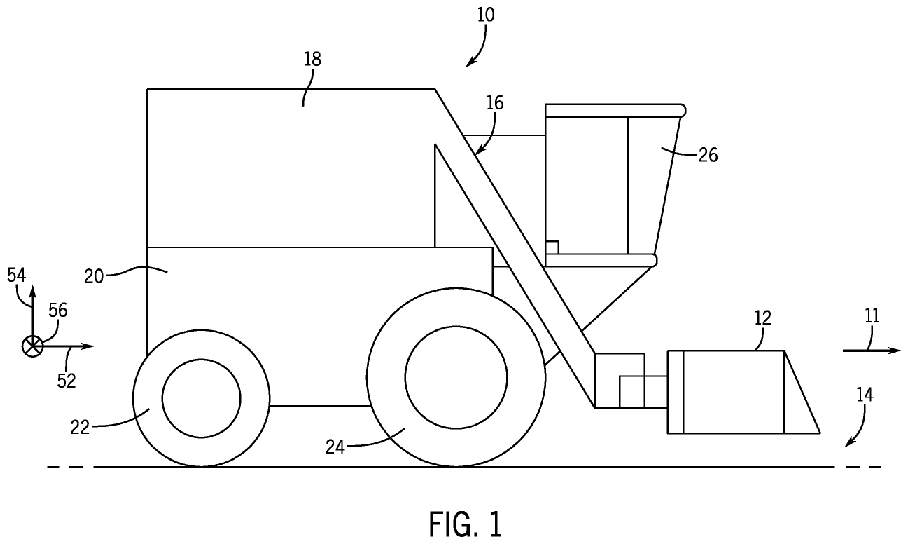

To facilitate discussion of FIGS. 1-3, an agricultural harvester 10 and its components are described with reference to a longitudinal axis or direction 52, a vertical axis or direction 54, and a lateral axis or direction 56. With the foregoing in mind, FIG. 1 is a schematic side view of an agricultural harvester 10 having a conveyor belt system 16 to facilitate delivery of harvested crops from a header 12 to a storage region 18 of the agricultural harvester 10. The agricultural harvester 10 also has a chassis 20, ground engaging wheels 22 and 24, and an operator cabin 26. The header 12 of the agricultural harvester 10 may include multiple heads that engage and collect agricultural crops (e.g., cotton or hay) as the agricultural harvester traverses a field 14 in a direction of travel 11. In the illustrated embodiment, the agricultural harvester 10 utilizes the conveyor belt system 16 to move harvested crops from the heads of the header 12 to a storage region 18 of the agricultural harvester 10. As mentioned above, the conveyor belt system 16 may utilize multiple conveyor belts to move the harvested crops from the heads of the header 12 to the storage region 18 of the agricultural harvester 10. For example, the conveyor belt system 16 may include an initial conveyor belt that conveys the harvested crops from the header 12 (e.g., individual heads of the header 12) of the agricultural harvester 10 to a pair of opposing conveyor belts that rotate in opposite directions to move the harvested crops to the storage region 18 of the agricultural harvester 10. As the conveyor belts rotate, the conveyor belts facilitate delivery of the harvested crops from the header 12 to the storage region 18 of the agricultural harvester 10, thereby reducing the amount of air introduced to the harvested crops as the harvested crops are delivered to the storage region 18, as compared to a pneumatic system.

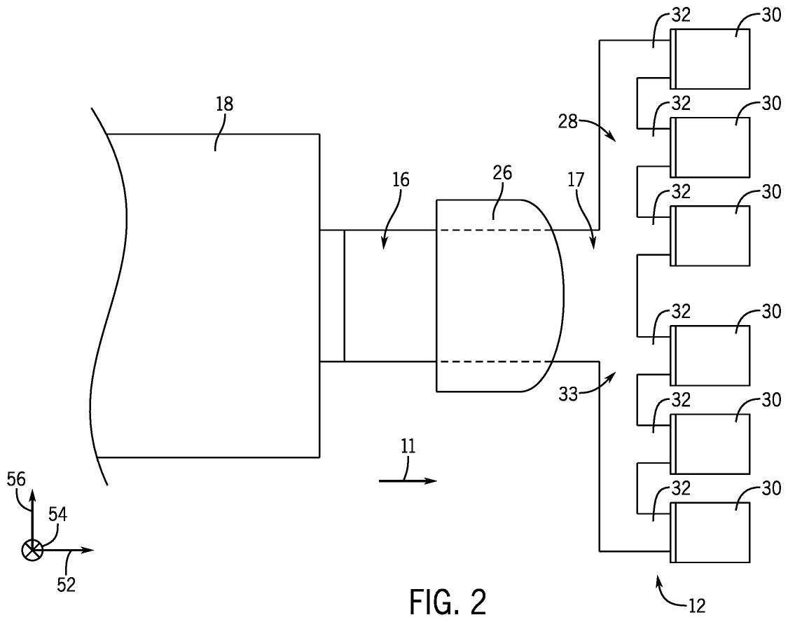

FIG. 2 is a schematic top view of the agricultural harvester 10 in which the header 12 has multiple heads 30 that may engage and collect agricultural crops as the agricultural harvester traverses 10 moves in the direction of travel 11 through a field. As the heads 30 collect the crops, a pneumatic system 28 of the header 12 may direct harvested crops toward the conveyor belt system 16 of the agricultural harvester 10. For example, respective air flows through pneumatic channels 32 may direct the harvested crops from the respective heads 30 toward an inlet 17 of the conveyor belt system 16. Although the header 12 has six pneumatic channels 32 that may facilitate delivery of the harvested crops from the six respective heads 30 toward the inlet 17 of the conveyor belt system 16 in the illustrated embodiment, in other embodiments, there may be more or fewer heads 30 and a corresponding number of pneumatic channels 32. For example, the header 12 may have one, two, three, four, five, seven, eight, nine, ten, or more heads 30, and a corresponding number of pneumatic channels 32 for facilitating delivery of the harvested crops from the heads 30 to the inlet 17 of the conveyor belt system 16. Additionally, the pneumatic channels 32 converge into a single, pneumatic channel 33 that is in fluid communication with inlet 17 of the conveyor belt system 16.

As described above, the conveyor belt system 16 may utilize conveyor belts to facilitate delivery of the harvested crops to the storage region 18 of the agricultural harvester 10. In the illustrated embodiment, a portion of the conveyor belt system 16 is disposed beneath the cabin 26 of the agricultural harvester 10 along the vertical axis 54. In other embodiments, however, the conveyor belt system 16 may be disposed adjacent to the cabin 26 or any other suitable location with respect to the cabin 26 to facilitate delivery of the harvested crops from the header 12 to the storage region 18 of the agricultural harvester 10.

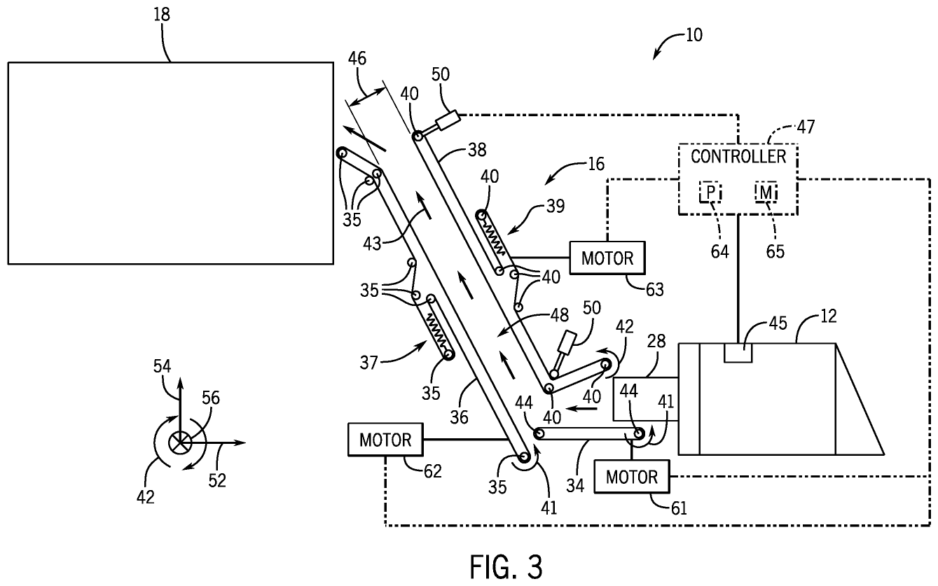

FIG. 3 is a schematic side view of the conveyor belt system 16 of FIG. 1, which is configured to facilitate delivery of harvested crops from one or more heads of the header 12 to the storage region 18 of the agricultural harvester 10. As heads of the header 12 collect crops, the pneumatic system 28 of the header 12 may direct harvested crops toward the conveyor belt system 16 of the agricultural harvester 10. As described above, the conveyor belt system 16 utilizes conveyor belts 34, 36, 38 to move the harvested crops from the heads of the header 12 to the storage region 18 of the agricultural harvester 10. In the illustrated embodiment, an initial conveyor belt 34 receives the harvested crops from the pneumatic system 28 of the header 12 and moves the harvested crops to a pair of opposing conveyor belts 36, 38 that rotate in opposite directions to move the harvested crops to the storage region 18 of the agricultural harvester 10. In some embodiments, the pair of opposing conveyor belts 36, 38 may be substantially parallel along the length of the conveyor belts 36, 38. For example, the pair of opposing conveyor belts 36, 38 may be substantially parallel for more than fifty percent of the length of at least one conveyor belt, more than sixty percent of the length of at least one conveyor belt, more than seventy percent of the length of at least one conveyor belt, more than eighty percent of the length of at least one conveyor belt, more than ninety percent of the length of at least one conveyor belt, or any other suitable percentage of the length of the at least one conveyor belt. As the conveyor belts 34, 36, 38 rotate, the conveyor belts 34, 36, 38 move the harvested crops from the header 12 to the storage region 18 of the agricultural harvester 10, thereby substantially reducing the amount of air introduced to the harvested crops as the harvested crops are delivered to the storage region 18, as compared to a pneumatic system.

In the illustrated embodiment, rotation of the initial conveyor belt 34 in the counterclockwise direction 41 may move the harvested crops received from the pneumatic system 28 along the longitudinal axis 52 toward the region 48 at least partially defined by the pair of opposing conveyor belts 36, 38. Once the harvested crops enter the region 48 between the pair of opposing conveyor belts 36, 38, rotation of the first conveyor belt 36 of the pair of opposing belts 36, 38 in the counterclockwise direction 41 and rotation of the second conveyor belt 38 of the pair of opposing belts 36, 38 in the clockwise direction 42 may move the harvested crops along the longitudinal axis 52 and along the vertical axis 54 toward the storage region 18 of the agricultural harvester 10. Although the harvested crops move in the direction 43 through the region 48 between the pair of opposing belts 36, 38 in the illustrated embodiment, in other embodiments, the pair of opposing belts 36, 38 may be disposed at a different angle and/or at a different position in the conveyor belt system 16 to establish a different direction of movement of the harvested crops. For example, the pair of opposing belts 36, 38 may be disposed at a fifteen degree angle, a thirty degree angle, a forty-five degree angle, a sixty degree angle, a seventy-five degree angle, or any other suitable angle with respect to the horizontal axis 52 of the agricultural harvester 10.

Each conveyor belt may have one or more tensioning legs that are configured to apply tension force to the conveyor belt, such that slippage between the conveyor belt and one or more rotors that support the conveyor belt is reduced. For example, the first conveyor belt 36 has a tensioning leg 37, and the conveyor belt 38 may have a tensioning leg 39. In certain embodiments, each conveyor belt may not have any tensioning legs, or each conveyor belt may have one tensioning leg, two tensioning legs, three tensioning legs, four tensioning legs, or any other suitable number of tensioning legs.

As the rotor(s) 44 of the initial conveyor belt 34 are driven to rotate by respective motor(s) 61 in a counter-clockwise direction, the rotor(s) 35 of the first conveyor belt 36 are driven to rotate by respective motor(s) 62 in the counter-clockwise direction 41, and the rotor(s) 40 of the second conveyor belt 38 are driven to rotate by respective motor(s) 63 in a clockwise direction 42, the conveyor belts 34, 36, 38 may rotate in corresponding directions to facilitate delivery of the harvested crops from the header 12 to the storage region 18 of the agricultural harvester 10. In certain embodiments, a single motor may drive each rotor of a conveyor belt, or a single motor may drive multiple rotors of the same conveyor belt or different conveyor belts. In some embodiments, the conveyor belts 34, 36, 38 may be formed from thermoplastic, metal, rubber, fabric, leather, another suitable material, or any combination thereof.

As mentioned above, various parameters of the conveyor belts may be adjusted for various crop yields, based on the type of crops, or the like. For example, a belt speed of at least one conveyor belt 34, 36, 38 may be increased or decreased based on the amount of harvested crops output by the header 12 of the agricultural harvester 10. In some embodiments, an operator may be able to manually adjust the rotational speed of the belt motor(s) 61, 62, 63 to control the belt speed of at least one conveyor belt 34, 36, 38. In certain embodiments, a controller 47 may receive a sensor signal indicative of the amount of harvested crops collected by the header 12 from one or more sensors 45 disposed in the header 12 (e.g., the one or more heads of the header 12). The sensor(s) 45 and the motor(s) 61, 62, 63 are communicatively coupled to the controller 47. The controller 47 may output respective command signal(s) to one or more belt motors to control the belt speed of at least one conveyor belt 34, 36, 38 based on the amount of harvested crops collected by the header 12. In this way, the belt speed of one or more conveyor belts 34, 36, 38 may be increased or decreased automatically based on a determined crop yield.

Additionally, a distance 46 between the conveyor belts 36, 38 may be adjustable to facilitate compression of the harvested crops in a region 48 between the conveyor belts 36, 38 as the harvested crops are delivered to the storage region 18 of the agricultural harvester 10. For example, the controller 47 may receive a sensor signal indicative of the amount of harvested crops output by the header 12 from the sensor(s) 45. Based on the sensor signal, the controller 47 may determine a target distance between the conveyor belts 36, 38 that may compress the harvested crops before the harvested crops are delivered to the storage region 18 of the agricultural harvester 10. The controller 47 may then output one or more command signals to one or more actuators 50 (e.g., hydraulic cylinders, pneumatic cylinders, linear actuators, or the like) communicatively coupled to the controller 47 that may adjust the position of the conveyor belt 38, such that the distance 46 between the conveyor belts 36, 38 is substantially equal to the target distance. Although the position of the conveyor belt 38 is adjusted with respect to the position of the conveyor belt 36 in the illustrated embodiment, in other embodiments, the position of the conveyor belt 36 may be adjusted with respect to the position of the conveyor belt 38 by one or more actuators, or the positions of both conveyor belts 36, 38 may be individually adjusted with respect to each other. In this way, the conveyor belts 36, 38 may be positioned at a target distance away from one another so that the harvested crops may be compressed as the harvested crops pass through the region 48 between the conveyor belts 36, 38 and are delivered to the storage region 18 of the agricultural harvester 10, thereby increasing the amount of crops that may be collected and stored in the agricultural harvester 10.

Further, the length of each conveyor belt may be adjustable to change the configuration of the agricultural harvester 10 from a crop harvesting mode to a transportation mode, or vice versa. For example, an operator may wish to use the agricultural harvester 10 to collect crops from a field. The operator may use the controller 47 to send a command signal to the tensioning leg(s) of the conveyor belts 34, 36, 38 to adjust the length (e.g., increase or decrease) of at least one of the conveyor belts 34, 36, 38 to facilitate movement of the harvested crops from the header 12 to the storage region 18 of the agricultural harvester 10. In another example, an operator may wish to use the agricultural harvester 10 to move the collected crops to another location. The operator may use the controller 47 to send a command signal to the tensioning leg(s) of the conveyor belts 34, 36, 38 to adjust the length (e.g., increase or decrease) of at least one of the conveyor belts 34, 36, 38. In this way, the agricultural harvester 10 may easily and efficiently switch between a crop harvesting mode and a transportation mode without changing or removing equipment between operation of the agricultural harvester 10 in each mode. In certain embodiments, the length of at least one of the conveyor belts 34, 36, 38 may also be adjusted via the tensioning leg(s) of the conveyor belts 34, 36, 38 to control the position along the conveyor belts 36, 38 from which the harvested crops may exit the region between the conveyor belts 36, 38 to the storage region 18 of the agricultural harvester 10. For example, the controller 47 may send a command signal to the tensioning leg(s) of the conveyor belts 36, 38 to adjust the length (e.g., increase or decrease) of at least one of the conveyor belts 36, 38 to control an exit position of the harvested crops along the conveyor belts 36, 38.

In certain embodiments, the conveyor belt system 16 may have more or less belts than the embodiments described above. For example, the conveyor belt system 16 may not have the initial conveyor belt 34 and the pair of opposing conveyor belts 36, 38 may receive the harvested crops from the pneumatic system 28. In another example, the conveyor belt system 16 may have two, three, four, or more initial conveyor belts to deliver the harvested crops to the pair of opposing conveyor belts 36, 38. Additionally, in certain embodiments, the conveyor belts of the conveyor belt system 16 may be in different positions and/or have different orientations than the embodiments described above. For example, the conveyor belts of the conveyor belt system 16 may have one turn, two turns, three turns, or any other suitable number of turns to move the harvested crops to the storage region of the agricultural harvester. Further, the conveyor belt system 16 may have any suitable number of conveyor belts. For example, the conveyor belt system 16 may have two conveyor belts, three conveyor belts, four conveyor belts, or more conveyor belts. The controller 47 has a processor 64 and a memory device 65. The processor 64 may be used to execute software, such as software for providing commands to the actuator(s), and so forth. Moreover, the processor 64 may include multiple microprocessors, one or more “general-purpose” microprocessors, one or more special-purpose microprocessors, and/or one or more application specific integrated circuits (ASICS), or some combination thereof. For example, upon installation of the software or other executable instructions on the processor 64, the processor 64 may become a special purpose processor configured to improve operation of conveyor belt system 16 using the techniques described herein. The memory device 65 may include a volatile memory, such as RAM, and/or a nonvolatile memory, such as ROM. The memory device 65 may store a variety of information and may be used for various purposes. For example, the memory device 65 may store processor-executable instructions for the processor to execute, such as instructions for providing commands to the actuator(s).

Technical effects of the improved agricultural harvester include reduced manufacturing and maintenance costs and/or increasing the amount of crops that may be stored in the agricultural harvester, as compared to an agricultural harvester having a pneumatic system for facilitating delivery of harvested crops from the header of the agricultural harvester to the storage region of the agricultural harvester. The improved agricultural harvester has a conveyor belt system that has relatively fewer components than the pneumatic system and that reduces the amount of air introduced to the harvested crops as the harvested crops are delivered to the storage region of the agricultural harvester, as compared to the pneumatic system. The conveyor belt system of the agricultural harvester has multiple conveyor belts that move the harvested crops from the heads of the header to the storage region of the agricultural harvester. For example, the conveyor belt system includes an initial conveyor belt that conveys the harvested crops from one or more heads of the agricultural harvester to a pair of opposing conveyor belts that rotate in opposite directions to move the harvested crops to the storage region of the agricultural harvester. As such, the amount of air introduced to the harvested crops as the harvested crops are delivered to the storage region from the heads is reduced, as compared to a pneumatic system. Additionally, various parameters of the conveyor belt system may be adjusted for various crop yields. For example, the distance between the conveyor belts and/or the belt speed of the conveyor belts may be increased or decreased based on the amount of crops harvested by the heads of the header. The distance between the conveyor belts may also be adjusted to facilitate compression of the harvested crops as the harvested crops are delivered to the storage region of the agricultural harvester, thereby increasing the amount of crops that may be collected and stored in the agricultural harvester.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any elements containing elements designated in any other manner, it is intended that such elements are not to be interpreted under 35 U.S.C. 112(f).

1. An agricultural harvester, comprising:
a header configured to harvest crops from a field and to output harvested crops;
a storage region configured to store the harvested crops; and
a conveyor belt system configured to move the harvested crops from the header to the storage region, wherein the conveyor belt system comprises:
a first conveyor belt; and
a second conveyor belt disposed a distance from the first conveyor belt;
wherein the first conveyor belt and the second conveyor belt are configured to receive the harvested crops in a region between the first conveyor belt and the second conveyor belt and rotate in opposite directions to move the harvested crops from the header to the storage region.

2. The agricultural harvester of claim 1, wherein the conveyor belt system comprises a third conveyor belt configured to provide the harvested crops from the header to the region between the first conveyor belt and the second conveyor belt.

3. The agricultural harvester of claim 1, wherein at least a portion of the conveyor belt system is configured to be disposed beneath a cabin of the agricultural harvester.

4. The agricultural harvester of claim 1, comprising:
one or more sensors disposed in the header; and
a controller configured to:
receive a signal indicative of an amount of the harvested crops from the one or more sensors; and
control one or more parameters of the conveyor belt system based on the signal.

5. The agricultural harvester of claim 4, wherein the one or more parameters comprise the distance between the first conveyor belt and the second conveyor belt, and the controller is configured to control the distance based on the signal.

6. The agricultural harvester of claim 4, wherein the one or more parameters comprise a belt speed of the first conveyor belt, a belt speed of the second conveyor belt, or both, and the controller is configured to control the belt speed of the first conveyor belt, the belt speed of the second conveyor belt, or both, based on the signal.

7. The agricultural harvester of claim 1, wherein a length of the first conveyor belt, a length of the second conveyor belt, or both, are adjustable to switch the agricultural harvester between a crop harvesting mode and a transportation mode.

8. The agricultural harvester of claim 1, wherein a length of the first conveyor belt, a length of the second conveyor belt, or both, are adjustable to change an outlet of the harvested crops from the conveyor belt system.

9. An agricultural harvester, comprising:
a conveyor belt system configured to facilitate delivery of harvested crops from one or more heads to a storage region of the agricultural harvester, wherein the conveyor belt system comprises:
a first conveyor belt;
a second conveyor belt disposed a distance from the first conveyor belt, wherein the first conveyor belt and the second conveyor belt are configured to rotate in opposite directions to facilitate delivery of the harvested crops to the storage region; and
a third conveyor belt configured to provide the harvested crops to a region between the first conveyor belt and the second conveyor belt.

10. The agricultural harvester of claim 9, wherein the first conveyor belt and the third conveyor belt are configured to rotate in a counterclockwise direction.

11. The agricultural harvester of claim 9, comprising:
one or more sensors disposed in each head of the one or more heads; and
a controller configured to:
receive a signal indicative of an amount of the harvested crops from the one or more sensors; and
control the distance between the first conveyor belt and the second conveyor belt based on the signal.

12. The agricultural harvester of claim 9, comprising:
one or more sensors disposed in each head of the one or more heads; and
a controller configured to:
receive a signal indicative of an amount of the harvested crops from the one or more sensors; and
control a belt speed of the first conveyor belt, the second conveyor belt, the third conveyor belt, or any combination thereof, based on the signal.

13. The agricultural harvester of claim 9, wherein rotation of the first conveyor belt and rotation of the second conveyor belt are configured to move at least a portion of the harvested crops along the first conveyor belt in both a longitudinal direction and a vertical direction with respect to the agricultural harvester.

14. An agricultural harvester, comprising:
a conveyor belt system configured to facilitate delivery of harvested crops from one or more heads to a storage region of the agricultural harvester, wherein the conveyor belt system comprises:
a first conveyor belt; and
a second conveyor belt disposed a distance from the first conveyor belt;
wherein the first conveyor belt and the second conveyor belt are configured to receive the harvested crops in a region between the first conveyor belt and the second conveyor belt and rotate in opposite directions to facilitate delivery of the harvested crops to the storage region; and
a controller configured to control one or more parameters of the conveyor belt system based on an amount of the harvested crops output by the one or more heads.

15. The agricultural harvester of claim 14, wherein the one or more parameters comprise the distance between the first conveyor belt and the second conveyor belt.

16. The agricultural harvester of claim 15, wherein the controller is configured to output a command signal to one or more actuators to control a position of the second conveyor belt with respect to a position of the first conveyor belt.

17. The agricultural harvester of claim 14, wherein the one or more parameters comprise a belt speed of the first conveyor belt, a belt speed of the second conveyor belt, or both.

18. The agricultural harvester of claim 14, comprising one or more respective pneumatic channels configured to facilitate delivery of the harvested crops from the one or more heads to the conveyor belt system.

19. The agricultural harvester of claim 18, wherein the conveyor belt system comprises a third conveyor belt configured to provide the harvested crops from the one or more respective pneumatic channels to the region between the first conveyor belt and the second conveyor belt.

20. The agricultural harvester of claim 19, wherein the third conveyor belt is configured to rotate in the same direction as the first conveyor belt.
